(19) United States
(12) Patent Application Publication
(10) Pub. No.: US 2005/0057659 A1
(43) Pub. Date: Mar. 17, 2005

(54) Camera image shake correcting device

(76) Inventor: Takami Hasegawa, Yokohama-shi (JP)

Correspondence Address: KANESAKA AND TAKEUCHI, 1423 Powhatan Street, Alexandria, VA, 22314, US

(21) Appl. No.: 10/662,439

(22) Filed: Sep. 16, 2003

(51) Int. Cl. H04N 5/228

(52) U.S. Cl. 348/208.11

(57) ABSTRACT

A camera image shake correcting device is provided which employs an image shake correcting system using an optical system to prevent image quality degradation and which uses a mirror (2) to allow improvement of correction response to image shake as well as miniaturization and to achieve a cost reduction.

The camera image shake correcting device is characterized by having a mirror (2) disposed in an intermediate portion of an optical path connecting together an image-formation plane of an image pickup optical system of a camera and an imaging lens; mirror driving means (7) for driving the mirror (2) so that the angle of the mirror (2) is changed in correspondence to displacement of an image on the image-formation plane caused by shake of the camera to cancel the displacement of the image on the image-formation plane; and control means (6) for controlling the mirror driving means (7) by detecting the amount of shake of the camera or the amount of displacement of the image on the image-formation plane.

### TECHNICAL FIELD OF THE INVENTION

The present invention relates to a camera image shake correcting device wherein image shake caused by camera shake when taking pictures is reduced by using an optical system, particularly a mirror.

### BACKGROUND ART

Recently, camera systems such as still cameras and video cameras have been equipped with various functions contributing to automation of photographing, e.g. automatic exposure control and automatic focusing control, and such camera systems have been put to practical use. One of the automating functions is camera image shake correcting means for reducing image shake due to camera shake, that is, hand shake, when taking pictures. The camera image shake correcting means is adopted as an essential function in most digital cameras and video cameras, particularly those that use a solid-state image sensor as an image pickup device and record image signals in a semiconductor memory or the like, for the following reasons:

1) Camera systems employing a solid-state image sensor as an image pickup device generally use a zoom lens as an imaging lens, and the zoom ratio of the zoom lens is increasing year by year. Therefore, slight shake of the camera system may appear as significant shake in the photographed image.

2) With the development of high-density packaging techniques, camera systems are decreasing in size, and solid-state image sensors are also decreasing in imaging field size. As a result, compact camera systems that allow photographing with a single hand have appeared. Consequently, camera shake is likely to occur when taking pictures.

The camera image shake correcting means that is most frequently used in the camera systems using a solid-state image sensor as an image pickup device is arranged as follows. The solid-state image sensor is driven so as to read an image signal from an area (hereinafter referred to as “window”) narrower than the effective pixel area of the solid-state image sensor, and the window is moved according to a control signal obtained from a shake detector provided in the camera system to pursue the subject image with the window at all times, thereby canceling the camera shake.

The image shake correcting means suffers, however, from the disadvantage that the image quality is unavoidably degraded because all the effective pixel area of the solid-state image sensor cannot be used to read the image signal.

Meanwhile, image shake correcting means using an optical system have been put to practical use as image shake correcting means that are not accompanied by image quality degradation. For example, there are available an image shake correcting means using a variangle prism (variable-apex angle prism) and an image shake correcting means using a lens group movable in a direction perpendicular to the optical axis of an image pickup optical system. Both are excellent image shake correcting means. However, either of the image shake correcting means uses a relatively heavy component and controls it to correct image shake by changing the angle of the component or moving it. Therefore, there are limits to the improvement of correction response to camera shake, and the reduction in size of the system is also limited.

### DISCLOSURE OF THE INVENTION

The present invention was made to solve the above-described problems with the background art. Accordingly, it is an object of the present invention to provide a camera image shake correcting device that employs image shake correcting means using an optical system to prevent image quality degradation and that uses a lightweight and compact mirror to allow improvement of correction response to image shake as well as miniaturization and to achieve a cost reduction. That is, the present invention provides the following:

(1) A camera image shake correcting device characterized by having a mirror disposed in an intermediate portion of an optical path connecting together an image-formation plane of an image pickup optical system of a camera and an imaging lens; mirror driving means for driving the mirror so that the angle of the mirror is changed in correspondence to displacement of an image on the image-formation plane caused by shake of the camera to cancel the displacement of the image on the image-formation plane; and control means for controlling the mirror driving means by detecting the amount of shake of the camera or the amount of displacement of the image on the image-formation plane.

(2) A camera image shake correcting device as stated in the above paragraph (1), which is characterized in that the mirror is disposed so as to reflect light incident thereon from the imaging lens at an angle of reflection in the range of from 35 to 55 degrees.

(3) A camera image shake correcting device as stated in the above paragraph (1) or (2), which is characterized in that the mirror is pivotable about the center of a reflecting surface thereof.

(4) A camera image shake correcting device as stated in any of the above paragraphs (1) to (3), which is characterized in that the mirror is a half-mirror or a beam splitter.

(5) A camera image shake correcting device as stated in any of the above paragraphs (1) to (3), which is characterized in that the mirror is an infrared reflecting mirror.

(6) A camera image shake correcting device as stated in any of the above paragraphs (1) to (5), which is characterized in that the mirror is a mirror-finished metal material or light-metal material, e.g. an aluminum alloy, or a glass or resin material with a thin metal film attached thereto.

### BRIEF DESCRIPTION OF THE DRAWINGS

FIG. 1 is a block diagram showing the arrangement of a 3-CCD video camera equipped with a camera image shake correcting device according to an embodiment of the present invention;

FIG. 2 is a back perspective view of mirror driving means in the embodiment of the present invention;

FIG. 3 is a front perspective view of mirror driving means in the embodiment of the present invention; and

FIG. 4 is a diagram for explaining an operation of correcting image shake by using a mirror.

### EXPLANATION OF REFERENCE SYMBOLS

1: zoom lens
1a: relay lens system
2, 2′, 2″: mirror
3: prism
4: solid-state image sensor (CCD)
5: displacement sensor unit
6: control means
7: mirror driving means
7a: Y axis driving unit
7b: X axis driving unit
8: frame
9a, 9b: displacement angle detecting unit
10: pivot shaft
a, a′: position of subject as viewed from camera
b, b′: position where subject image is formed
α, α′: reflection angle
β: angle at which displacement of subject image is viewed
θ: tilt angle of camera

### BEST MODE FOR CARRYING OUT THE INVENTION

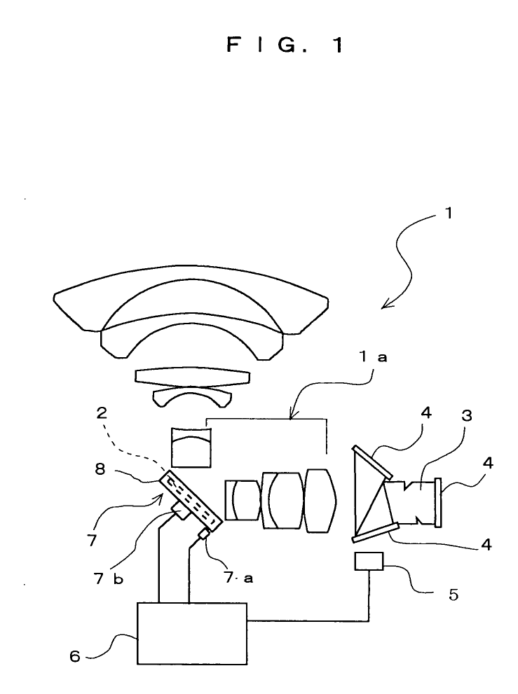

An embodiment of the present invention will be described below on the basis of an example in which the present invention is applied to a 3-CCD video camera as shown in FIG. 1.

The camera image shake correcting device according to the present invention comprises, as seen in FIG. 1, a mirror 2 disposed in an intermediate portion of an optical path along which light entering an image pickup optical system of the camera travels to reach solid-state image sensors 4. The mirror 2 is pivotable in both an X axis direction and a Y axis direction. A mirror driving means 7 pivots the mirror 2 in the X axis and Y axis directions so that displacement of a subject image on each solid-state image sensor 4 caused by shake of the camera is corrected by a change in the reflection angle of the mirror 2. A displacement sensor unit 5 detects the direction and amplitude of shake of the camera or the direction and magnitude of displacement of the subject image on the solid-state image sensor 4. A control means 6 controls the pivoting angle and pivoting speed of the mirror driving means 7 according to a displacement signal output from the displacement sensor unit 5.

The embodiment shown in FIG. 1 is a color video camera having a mirror 2 disposed in a relay lens system 1a constituting a part of a zoom lens 1 in such a manner that the reflection angle of the mirror 2 is 45 degrees. Thus, the optical path of a subject image taken by the zoom lens 1 is changed 90 degrees by the mirror 2, and the subject image is formed on the light-receiving surfaces of three solid-state image sensors 4 through a color separation prism 3 to obtain a color image.

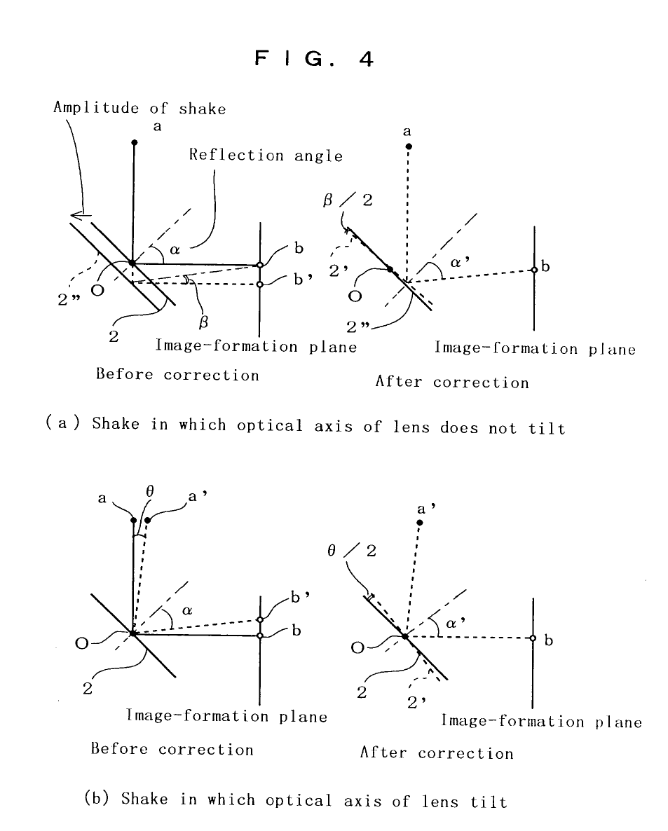

A phenomenon when the color video camera having the above-described arrangement shakes will be explained with reference to parts (a) and (b) of FIG. 4. For explanatory simplicity, part (a) of FIG. 4 shows camera shake in which the optical axis of the camera translates without tilting, and part (b) of FIG. 4 shows camera shake in which the optical axis of the camera tilts. Usually, however, the two different kinds of camera shake are likely to occur simultaneously.

Assuming that the mirror 2 is moved to the position 2″ by camera shake causing the camera to translate, as shown in part (a) of FIG. 4, the image of a subject a on the image-formation plane moves from the position b to the position b′. The shift of the position of the subject image is recognized as shake of the image. Therefore, it is necessary to make the subject image remain at the position b on the image-formation plane even when the mirror 2 moves to the position 2″. To keep the subject image at the position b, the direction of a light beam reflected from the mirror 2″ needs to be changed upward through an angle β. Therefore, the mirror 2″ is pivoted about the center O thereof through an angle β/2 to become a corrected mirror 2′, thereby attaining the purpose.

When the camera shakes in such a manner that the optical axis thereof tilts, as shown in part (b) of FIG. 4, the angle at which the camera views the subject changes by θ angle owing to the tilting of the camera. Accordingly, the angle of reflection at the mirror 2 also becomes smaller than 45 degrees by θ angle. As a result, the position of the subject image on the image-formation plane also moves from b to b′. The shift of the position of the subject image is recognized as shake of the image. Therefore, it is necessary to make the subject image remain at the position b on the image-formation plane even when the mirror 2 tilts and hence the angle at which the camera views the subject changes. To keep the subject image at the position b, the reflection angle α of the mirror 2 needs to be changed. Therefore, the mirror 2 is pivoted about the center O thereof through an angle θ/2, thereby attaining the purpose.

To allow the mirror 2 to perform the above-described operation, a displacement sensor (liquid inertia-applied displacement sensor or the like) unit 5 is provided in the camera body to detect the amplitude and velocity of camera shake in each of horizontal and vertical directions. A displacement signal obtained from the displacement sensor unit 5 is amplified by an amplifier (not shown) before being applied to a control means 6 having a CPU to calculate a pivoting angle of the mirror 2 corresponding to the displacement signal. Then, the mirror driving means 7 is driven on the basis of the calculated data to control the pivoting angle of the mirror 2.

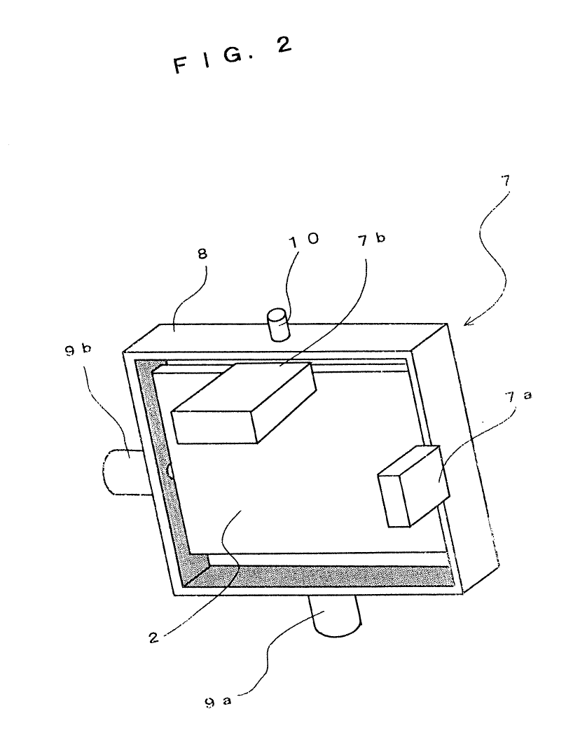

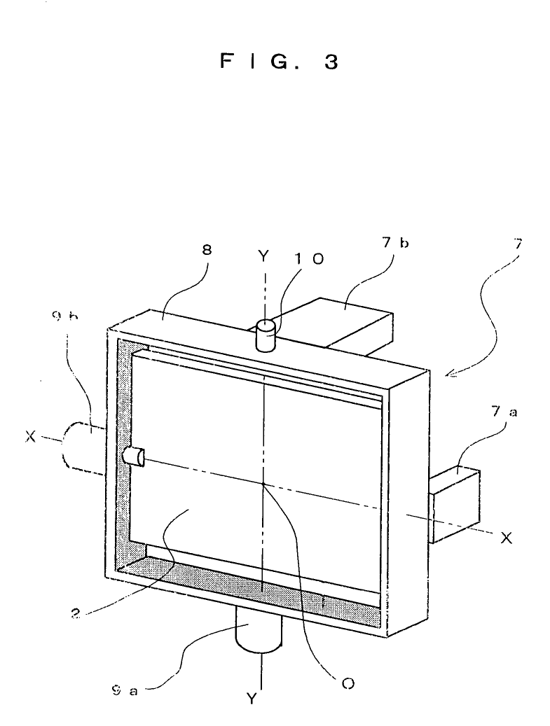

As shown in FIGS. 2 and 3, the mirror driving means 7 has a frame 8 in which the reflecting mirror 2 is pivotally mounted so as to be pivotable about an X axis. The frame 8 is pivotally attached to the zoom lens 1 (see FIG. 1) or the camera body (not shown) through a Y axis pivot shaft 10 so as to be pivotable about the Y axis pivot shaft 10.

In addition, an X axis driving unit 7b is secured to the frame 8. The X axis driving unit 7b pivots the mirror 2 about the X axis to correct vertical shake of the camera. A Y axis driving unit 7a is secured to the zoom lens 1 or the camera body. The Y axis driving unit 7a pivots the frame 8 about the Y axis to correct horizontal shake of the camera. Further, an X axis displacement angle detecting unit 9b for detecting the displacement angle of the mirror 2 is attached to the X axis pivot shaft, and a Y axis displacement angle detecting unit 9a for detecting the displacement angle of the frame 8 is attached to the Y axis pivot shaft.

It should be noted that the X axis and the Y axis pass through the center O of the reflecting surface of the mirror 2, as a matter of course.

The X axis driving unit 7b comprises a plate-shaped (or bar-shaped) magnetic member (not shown) secured to the upper or lower edge portion of the mirror 2 and a coil (not shown) provided in the X axis driving unit 7b. The X axis driving unit 7b drives the magnetic member by utilizing the force of attraction or repulsion acting between the coil and the magnetic member when magnetic force is produced by passing an electric current through the coil.

More specifically, a displacement signal indicating vertical shake of the camera detected by the displacement sensor unit 5 (see FIG. 1) is applied to the control means 6 (see FIG. 1) having a CPU to calculate a displacement angle corresponding to the displacement signal through which the mirror 2 should be pivoted about the X axis. A control signal based on the calculated data is input to the X axis driving unit 7b, and a driving current is passed through the coil provided in the X axis driving unit 7b, whereby the magnetic member secured to the mirror 2 is driven to be pushed out forward or withdrawn backward. As a result, the mirror 2, which is pivotally attached to the frame 8, pivots about the X axis counter to the vertical shake of the camera in accordance with the amplitude and velocity of the vertical camera shake to cancel the vertical shake, thereby correcting the camera shake.

The Y axis driving unit 7a comprises a plate-shaped (or bar-shaped) magnetic member (not shown) secured to the left or right end of the frame 8 and a coil (not shown) provided in the Y axis driving unit 7a. The Y axis driving unit 7a drives the magnetic member by utilizing the force of attraction or repulsion acting between the coil and the magnetic member when magnetic force is produced by passing an electric current through the coil.

More specifically, a displacement signal indicating horizontal shake of the camera detected by the displacement sensor unit 5 (see FIG. 1) is applied to the control means 6 (see FIG. 1) having a CPU to calculate a displacement angle corresponding to the displacement signal through which the frame 8 should be pivoted about the Y axis. A control signal based on the calculated data is input to the Y axis driving unit 7a, and a driving current is passed through the coil provided in the Y axis driving unit 7a, whereby the magnetic member secured to the frame 8 is driven to be pushed out forward or withdrawn backward. As a result, the frame 8, which is pivotally attached to the zoom lens 1 or the camera body, pivots about the Y axis counter to the horizontal shake of the camera in accordance with the amplitude and velocity of the horizontal camera shake to cancel the horizontal shake, thereby correcting the camera shake.

If the X axis driving unit 7b and the Y axis driving unit 7a are driven simultaneously, camera shake in any direction can be corrected, as a matter of course.

The X axis displacement angle detecting unit 9b detects the displacement angle of the mirror 2 by using a rotary encoder or the like. The Y axis displacement angle detecting unit 9a detects the displacement angle of the frame 8 by using a rotary encoder or the like. The data detected by the X axis displacement angle detecting unit 9b and the Y axis displacement angle detecting unit 9a is fed back to the control means 6 and compared with a displacement signal from the displacement sensor unit 5 to perform an operation whereby the mirror 2 is stopped at a correct displacement angle position for correcting the camera shake.

Although in the foregoing embodiment the mirror driving means 7 has been described as a moving magnet type driving means, the mirror driving means 7 is not necessarily limited thereto but may be any publicly known driving means, e.g. a moving coil type driving means, or a driving means using a microminiature motor.

It should be noted that the mirror 2 is preferably produced from a metal material or light-metal material, e.g. an aluminum alloy, having a mirror-finished reflecting surface, or a glass or resin material with a thin metal film attached to a reflecting surface.

Further, a half-mirror or a beam splitter may be used in place of the mirror 2 to divide the subject image into two when an autofocus device is provided at the back of the mirror 2 in order to equip the camera with an autofocus function.

Furthermore, if the mirror 2 is an infrared reflecting mirror, an infrared camera with a shake correction function can be obtained.

Further, although in the foregoing embodiment the mirror 2 is disposed in the relay lens system 1a constituting a part of the zoom lens 1 in such a manner that the reflection angle of the mirror 2 is 45 degrees, the mirror 2 may be positioned between the zoom lens 1 and the prism 3. Further, the mirror 2 may be disposed so as to reflect light incident thereon from the imaging lens at an angle of reflection in the range of from 35 to 55 degrees.

In addition, although in the foregoing embodiment the present invention has been described with regard to a 3-CCD color video camera, the present invention may also be applied to a single-CCD video camera. The present invention is also applicable to a still camera using silver halide film.

In the case of a video camera using a CCD as in the foregoing embodiment, the means for detecting the amplitude and velocity of camera shake may be arranged to detect a motion vector from an image signal output from the camera by making full use of a digital image processing technique.

In this case, it is necessary to make a discrimination between motion due to camera shake, motion of the subject itself and motion due to a camera operation. For this purpose, it is preferable to use a publicly known technique capable of effectively discriminating complicated motions from each other, e.g. an image signal detecting method using fuzzy inference.

### INDUSTRIAL APPLICABILITY

A mirror is disposed in an intermediate portion of an optical path connecting together an image-formation plane of an image pickup optical system of a camera and an imaging lens, and the angle of the mirror is changed in correspondence to displacement of an image on the image-formation plane caused by shake of the camera to cancel the displacement of the image on the image-formation plane. Therefore, it is possible to correct camera image shake without image quality degradation and hence possible to realize a compact camera with minimal image quality degradation due to shake such as hand shake.

As the mirror, it is possible to use any mirror selected from among visible-light mirrors such as a reflecting mirror using a mirror-finished metal material or light-metal material, e.g. an aluminum alloy, or a glass or resin material with a thin metal film attached thereto, a half-mirror, or a beam splitter, which provides a high light utilization efficiency, and infrared reflecting mirrors. Therefore, the application range of cameras can be expanded.

Because it is compact and lightweight, the mirror becomes easy to drive. Accordingly, it is possible to realize a camera image shake correcting device excellent in response characteristics to camera shake.

1. A camera image shake correcting device comprising:
a mirror disposed in an intermediate portion of an optical path connecting together an image-formation plane of an image pickup optical system of a camera and an imaging lens;
mirror driving means for driving the mirror so that an angle of the mirror is changed in correspondence to displacement of an image on the image-formation plane caused by shake of the camera to cancel the displacement of the image on the image-formation plane; and
control means for controlling said mirror driving means by detecting an amount of shake of the camera or an amount of displacement of the image on the image-formation plane.

2. A camera image shake correcting device according to claim 1, wherein said mirror is disposed so as to reflect light incident thereon from the imaging lens at an angle of reflection in a range of from 35 to 55 degrees.

3. A camera image shake correcting device according to claim 1, wherein said mirror is pivotable about a center of a reflecting surface thereof.

4. A camera image shake correcting device according to claim 1, wherein said mirror is a half-mirror or a beam splitter.

5. A camera image shake correcting device according to claim 1, wherein said mirror is an infrared reflecting mirror.

6. A camera image shake correcting device according to claim 1, wherein said mirror is a mirror-finished metal material or light-metal material, for example, an aluminum alloy, or a glass or resin material with a thin metal film attached thereto.
